(19) United States
(12) Patent Application Publication
(10) Pub. No.: US 2001/0003616 A1
(43) Pub. Date: Jun. 14, 2001

(54) MAGNETIC RECORDING MEDIUM

(76) Inventors: SEIICHI ONODERA, MIYAGI (JP); TETSUO SAMOTO, MIYAGI (JP); TAKAHIRO KAWANA, MIYAGI (JP)

Correspondence Address: DAVID R. METZGER, SONNENSCHEIN NATH & ROSENTHAL, P.O. BOX #061080, WACKER DRIVE STATION, SEARS TOWER, CHICAGO, IL, 60606-1080, US

(21) Appl. No.: 09/225,424

(22) Filed: Jan. 5, 1999

(30) Foreign Application Priority Data
Jan. 6, 1998 (JP) P10-001136

(51) Int. Cl. G11B 5/65; B32B 5/16

(52) U.S. Cl. 428/328

(57) ABSTRACT

A magnetic recording medium comprising a thin magnetic metal film of which the thickness and remanent magnetization are smaller than ever and optimized to match the characteristics of the MR read head used with the recording medium. The thin magnetic metal film is formed on a nonmagnetic substrate and has a remanent magnetization and film thickness product Mr·δ of 1 to 5 memu/cm². Owing to this product Mr·δ, a signal recorded on the magnetic recording medium can be reproduced with no distortion in a region where the MR read head maintains its linearity.

### BACKGROUND OF THE INVENTION

1. Field of the Invention

The present invention relates to a magnetic recording medium of a so-called magnetic metal film type, and more particularly, to a magnetic recording medium suitable for use with a helical scanning magnetic recording system incorporating a magnetoresistance effect type read head.

2. Description of Related Art:

Many of the conventional magnetic recording media are of a so-called coated type. Namely, they are produced by applying a nonmagnetic support or substrate with a magnetic coating prepared by dispersing a magnetic material powder such as a magnetic oxide powder or magnetic alloy powder into an organic binder such as a copolymer of polyvinyl chloride and polyvinyl acetate, polyester resin, polyurethane resin or the like, and then drying the applied magnetic coating.

However, magnetic recording media capable of recording at a higher density have been demanded increasingly more and more. To meet such a demand, a magnetic recording medium of a so-called magnetic metal film type has been proposed and attracting the attention in the field of art. In this medium, a nonmagnetic substrate or substrate is coated directly with a magnetic metallic material such as Co—Ni, Co—Cr, Co—O, Co—Ni—O, Co—Pt, Co—Pt—O or the like by plating or vacuum thin-film forming (vacuum evaporation, sputtering, ion plating, or the like).

The magnetic recording medium of this thin magnetic metal film type is superior in coercivity, remanent magnetization, squareness, etc. as well as in electromagnetic conversion characteristic in the short-wave domain. Further, since the magnetic layer can be made extremely thin so that the thickness-caused loss during recording demagnetization and reproduction is small, and it is not necessary to mix any binder being a nonmagnetic material in the magnetic layer, the magnetic recording medium of the thin magnetic metal film type have various advantages such as high packing density of magnetic materiel, large magnetization, etc.

Furthermore, for an improvement of the electromagnetic conversion of such magnetic recording media to provide a larger output, a so-called oblique evaporation has been proposed to evaporate a magnetic layer obliquely on a substrate in forming the magnetic layer of the magnetic recording medium. The magnetic tape thus produced is used in a high quality VTR and digital VTR.

The magnetic recording medium of the thin magnetic metal film type (so-called evaporation tape) are advantages as in the above. When it is replayed with a high sensitivity magnetic head of the magnetoresistance effect type (MR head), it will produce so large an amount of magnetic flux that the magnetic head will deviate from a tape region where the MR head maintains its linearity. Thus, information cannot be read without distortion.

The evaporation tape can be replayed with a substantially lower noise than the coated type magnetic recording medium and advantageously used with an MR head. For no MR device saturation and distortion, it is necessary to optimize a film thickness and remanent magnetization on which the amount of magnetic flux on the surface of the magnetic recording medium depends.

### SUMMARY OF THE INVENTION

Accordingly, the present invention has an object to overcome the above-mentioned drawbacks of the prior art by providing a magnetic recording medium comprising a thin magnetic metal film formed as a magnetic layer and that has a film thickness and remanent magnetization both optimized to match the characteristics of an MR head and capable of attaining an incomparably high density of recording when used with a helical scanning magnetic recording system incorporating an MR head, for example.

The above object can be achieved by providing a magnetic recording medium comprising a thin magnetic metal film formed as a magnetic layer, of which the thickness and remanent magnetization are optimized to match the characteristics of an MR read head by reducing them more than ever.

More particularly, the magnetic recording medium according to the present invention comprises a nonmagnetic substrate, and a thin magnetic metal film formed on the nonmagnetic substrate and of which the product Mr·δ of the remanent magnetization Mr and film thickness δ is 1 to 5 memu/cm².

Because the thin magnetic metal film has the product Mr·δ of the remanent magnetization Mr and film thickness δ within the above range, signal reproduction is possible without any distortion in a region where the MR read head maintains its linearity.

### BRIEF DESCRIPTION OF THE DRAWINGS

These objects and other objects, features and advantages of the present intention will become more apparent from the following detailed description of the present invention when taken in conjunction with the accompanying drawings, of which:

FIG. 1 is a schematic perspective view of a rotary drum unit incorporated in a helical scanning magnetic recording/reproducing apparatus, with which the magnetic recording medium according to the present invention can be used;

FIG. 2 is a plan view of a magnetic tape feeding mechanism incorporating the rotary drum unit in FIG. 1;

FIG. 3 is a sectional view of the rotary drum unit, showing the internal construction thereof;

FIG. 4 is a schematic circuit diagram of the rotary drum unit and its peripheral circuitry;

FIG. 5 is a perspective view of an MR head incorporated in the rotary drum unit; and

FIG. 6 is a schematic drawing showing a signal reproduction by the MR head from the magnetic tape.

### DETAILED DESCRIPTION OF THE PREFERRED EMBODIMENTS

The magnetic recording medium according to the present invention comprises a nonmagnetic substrate, and a thin magnetic metal film formed as a magnetic layer on the substrate and of which the thickness and remanent magnetization are optimized to match the characteristics of the MR read head by reducing them more than ever.

The thickness of the thin magnetic metal film can be controlled by changing the production line speed, and the remanent magnetization can be controlled by changing the introduced amount of oxygen during evaporation.

By controlling these two parameters as above, a maximum output is obtainable with no saturation of the MR read head and distortion. More specifically, the product Mr·δ of the remanent magnetization Mr and film thickness δ is 1 to 5 memu/cm².

If the product MR·δ is under 1 memu/cm², no sufficient reproduction output can be obtained. On the contrary, if the product is over 5 memu/cm², the MR read head will be saturated, resulting in a distortion.

When the product MR·δ is within the above-specified range, it is possible to freely set the film thickness and remanent magnetization. However, it the film thickness δ and remanent magnetization Mr are too small, it is difficult to have a product MR·δ over 1 memu/cm². Reversely, if the film thickness δ and remanent magnetization Mr are set too large, a distortion will be caused.

Therefore, the film thickness δ of the thin magnetic metal film should preferably be 30 to 120 nm, and the remanent magnetization Mr be 200 to 400 emu/cc.

Also the coercivity in the inplane direction of the magnetic recording medium according to the present invention has to be maintained greater than 1,000 Oe in order to implement a low noise and high resolution. However, if the coercivity exceeds 2,500 Oe, no satisfactory recording becomes possible and the reproduction output is lower. Accordingly, the coercivity should preferably be 1,000 to 2,500 Oe.

For both the high resolution and low noise, the squareness in the inplane direction of the magnetic recording medium should preferably be within a range of 0.6 to 0.9.

The material of the thin magnetic metal film includes Co-based ones such as Co, Co—Ni, Co—Cr, Co—O, Co—Ni—O, Co—Pt, Co—Pt—O and their oxides.

According to the present invention, the magnetic recording medium may comprises a protective layer formed on the surface of the magnetic layer to protect the magnetic layer. The protective layer may be formed from any material which would be usable as a protective layer for a common thin magnetic metal film. The material includes carbon, CrO₂, Al₂O₃, B oxide, Co oxide, MgO, SiO₂, Si₃O₄, SiNₓ, SiC, SiNₓ—SiO₂, ZrO₂, TiO₂, TiC, etc. for example. The protective layer may be a single layer made of any one of the materials, or a multiple or composite layer made of two or more of the materials.

Of course, the magnetic recording medium according to the present invention is not limited to the above-mentioned configuration, but it may further comprise an undercoat layer formed on the nonmagnetic substrate thereof, a backcoat layer provided on the opposite side of the nonmagnetic substrate to the side on which the thin magnetic metal film is formed and/or a topcoat layer made of a lubricant, rust-preventive agent or the like and formed on the thin magnetic metal film or protective layer.

The magnetic recording medium is suitably usable as a magnetic tape with a helical scan magnetic recording system incorporating an MR read head.

In this case, the MR head is a shielded type one in which an MR device is sandwiched between shielding layers. It is incorporated in a rotary drum to form a recording/reproducing apparatus.

Combination of the helical scan magnetic recording system using the MR head and the magnetic recording medium according to the present invention can attain a high density of recording.

The magnetic recording/reproducing apparatus of the helical scan magnetic recording type uses the rotary drum for signal recording and reproduction, and the MR head incorporated in the rotary drum as a reproduction magnetic head.

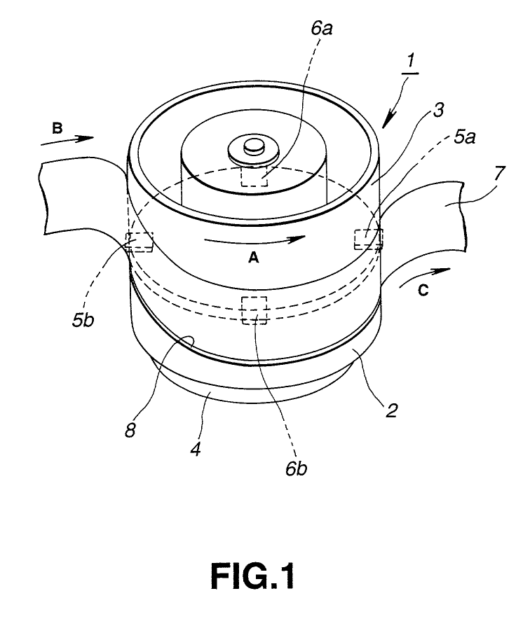

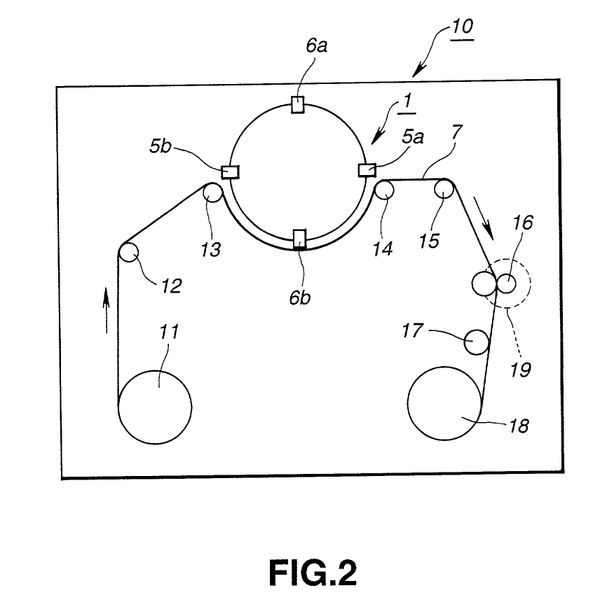

FIGS. 1 and 2 show together an example of the configuration of the rotary drum unit used in the magnetic recording/reproducing apparatus. FIG. 1 is a schematic perspective view of the rotary drum unit 1, and FIG. 2 is a schematic plan view of a tape feeding mechanism 10 incorporating the rotary drum unit 1.

As shown in FIG. 1, the rotary drum unit 1 comprises a cylindrical stationary drum 2, a cylindrical rotary drum 3, a motor 4 provided to rotate the rotary drum 3, a pair of inductive type magnetic heads 5a and 5b mounted in the rotary drum 3, and a pair of MR heads 6a and 6b mounted in the rotary drum 3.

The stationary drum 2 is stationary, not rotatable. A lead guide 8 is formed in the side face of the stationary drum 2 in the running direction of a magnetic tape 7. As will be described later, the magnetic tape 7 runs along the lead guide 8 during recording/reproduction. The rotary drum 3 is disposed concentrically with the stationary drum 2.

The rotary drum 3 is rotated at a predetermined speed by the motor 4 when recording onto or reproducing from the magnetic tape 7. The rotary drum 3 is a cylinder having a nearly same diameter as the stationary drum 2. The rotary drum 3 has provided on the bottom thereof facing the stationary drum 2 the pair of inductive type magnetic heads 5a and 5b and the pair of MR heads 6a and 6b.

Each of the inductive type magnetic heads 5a and 5b is a recording magnetic head comprising a pair of magnetic cores joined to each other with a magnetic gap between them and a coil wound on each magnetic core. The magnetic heads 5a and 5b are used to record a signal onto the magnetic tape 7. The magnetic heads 5a and 5b are disposed opposite to each other diametrically of the rotary drum 3 and with the magnetic gap thereof projected from the perimeter of the rotary drum 3. They are set to have opposite azimuth angles for an azimuth recording onto the magnetic tape 7.

Each of the MR heads 6a and 6b is a reproducing magnetic head comprising an MR device to detect a signal from the magnetic tape 7. Similarly to the magnetic heads 5a and 5b, the MR heads 6a and 6b are disposed opposite to each other diametrically of the rotary drum 3 and with the magnetic gap thereof projected from the perimeter of the rotary drum 3. They are set to have opposite azimuth angles for reproduction of a signal azimuth-recorded on the magnetic tape 7.

The magnetic recording/reproducing apparatus allows the rotary drum unit 1 to slide the magnetic tape 7 for recording or reproducing a signal onto or from the magnetic tape 7.

More particularly, the magnetic tape 7 is fed from a supply reel 11 over guide rollers 12 and 13 and then the rotary drum unit 1 for recording or reproduction, as shown in FIG. 2. The magnetic tape 7 having recorded a signal onto it by the rotary drum unit 1 or from which a signal has reproduced by the rotary drum unit 1 is fed over guide rollers 14 and 15, capstan 16 and guide roller 17 to a take-up reel 18. The magnetic tape 7 is tensioned and fed by the capstan 16 rotated by a capstan motor 19, and wound onto the take-up reel 18.

The rotary drum 3 is rotated by the motor 4 as indicated with an arrow A in FIG. 1. On the other hand, the magnetic tape 7 is fed along the lead guide 8 in the stationary drum 2 while obliquely sliding on the stationary drum 2 and rotary drum 3. More particularly, the magnetic tape 7 is fed from a tape inlet as indicated with an arrow B in FIG. 1 and slid on the stationary drum 2 and rotary drum 3 along the lead guide 8, and then to a tape outlet, as indicated with an arrow C in FIG. 1.

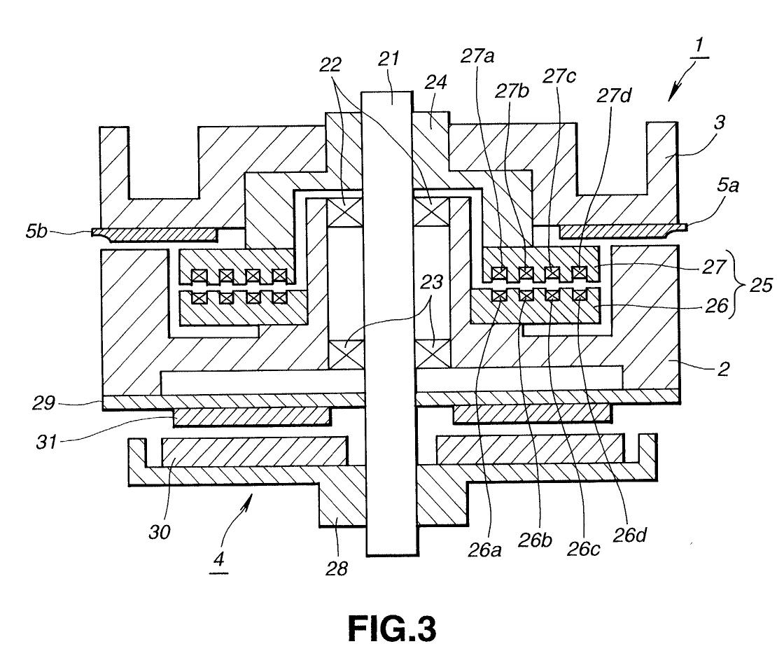

Next, the internal structure of the rotary drum unit 1 will be described below with reference to FIG. 3.

As seen, a rotating shaft 21 is penetrated through the centers of the stationary and rotary drums 2 and 3. Note that the stationary and rotary drums 2 and 3 and the rotating shaft 21 are made of an electrically conductive material. Therefore, they are electrically conductive and the stationary drum 2 is electrically connected to the ground potential.

There are provided inside the sleeve of the stationary drum 2 two bearings 22 and 23 which support together the rotating shaft 21 to be rotatable in the stationary drum 2. The rotary drum 3 is flanged along the inner perimeter thereof as indicated with a reference number 24. The flange 24 is fixed to the upper end of the rotating shaft 21, whereby the rotary drum 3 is rotatable as the rotating shaft 21 rotates.

For signal transmission between the stationary and rotary drums 2 and 3, a rotary transformer 25 of a non-contact type is provided inside the rotary drum unit 1. The rotary transformer 25 comprises a stator core 26 installed on the stationary drum 2 and a rotor core 27 installed on the rotary drum 3.

The stator core 26 and rotor core 27 are formed toroidally around the rotating shaft 21 from a magnetic material such as ferrite. There are disposed concentrically in the stator core 26 a pair of signal transmitting rings 26a and 26b corresponding to the pair of inductive type magnetic heads 5a dn 5b, a signal transmitting rings 26c corresponding to the pair of MR heads 6a and 6b, and a power transmitting ring 26d destined to supply a power required for driving the pair of MR heads 6a and 6b. Also, there are disposed concentrically in the rotary core 27 a pair of signal transmitting rings 27a and 27b corresponding to the pair of inductive type magnetic heads 5a and 5b, a signal transmitting ring 27c corresponding to the pair of MR heads 6a and 6b, and a power transmitting ring 27d destined for supplying a power required for driving the pair of MR heads 6a and 6b.

Each of the above rings 26a, 26b, 26c, 26d, 27a, 27b, 27c and 27d is a coil wound toroidally abut the rotating shaft 21. The rings 26a, 26b, 26c and 26d of the stator core 26 are disposed opposite to the rings 27a, 27b, 27c and 27d, respectively, of the rotary core 27. The rotary transformer 25 transmits a signal and power in a non-contact manner between the rings 26a, 26b, 26c and 26d of the stator core 26 and the rings 27a, 27b, 27c and 27d, respectively.

As previously described, the rotary drum unit 1 has coupled thereto the motor 4 to rotate the rotary drum 3. The motor 4 comprises a rotor 28 and a stator 29. The rotor 28 has a driving magnet 30 and is coupled to the bottom of the rotating shaft 21, and the stator 29 has a driving coil 31 and is fixed to the bottom of the stationary drum 2. When the driving coil 31 is supplied with a current, the rotor 28 is driven to rotate the rotating shaft 21. Thus, the rotary drum 3 coupled to the rotating shaft 21 is rotated.

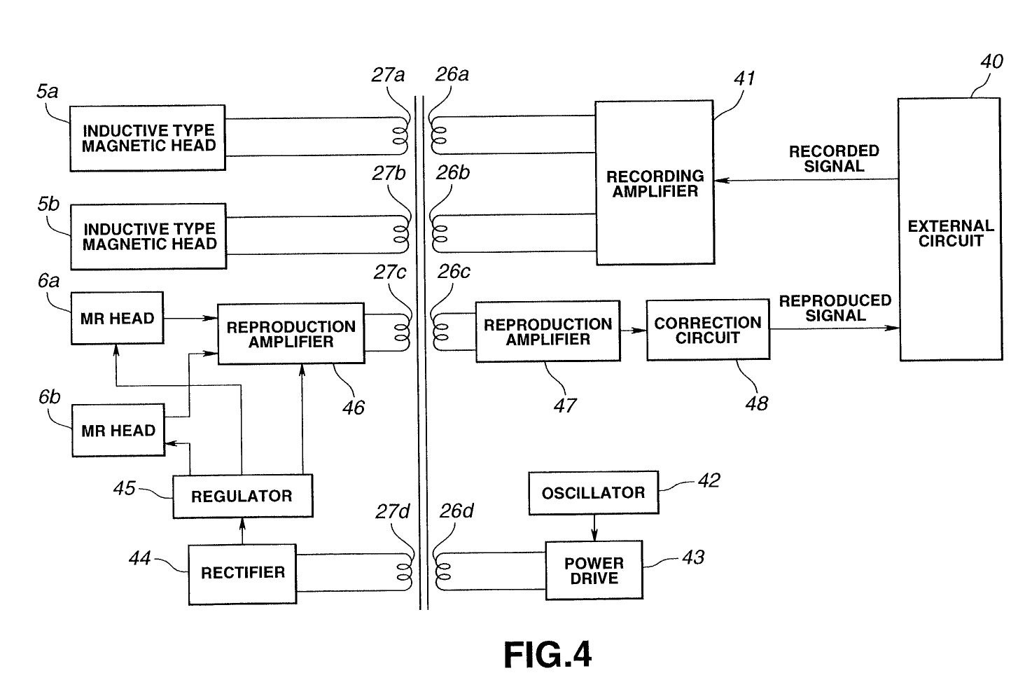

Next, the recording/reproduction by the rotary drum unit 1 will be described with reference to FIG. 4 schematically showing the circuit configuration of the rotary drum unit 1 and its peripheral circuitry.

For recording a signal onto the magnetic tape 7 by means of the rotary drum unit 1, a current is first supplied to the driving coil 31 of the motor 4, thus the rotary drum 3 is rotated. While the rotary drum 3 is rotating, the recorded signal from an external circuit 40 is supplied to a recording amplifier 41 as shown in FIG. 4.

The recording amplifier 41 amplifies the recorded signal from the external circuit 40 and supplies it to the signal transmitting ring 26a of the stator core 26 corresponding to one of the inductive type magnetic heads 5a at a timing of signal recording by the inductive type magnetic head 5a. The recorded signal is supplied to the signal transmitting ring 26b of the stator core 26 corresponding to the other inductive type magnetic head 5b at a timing of signal recording by the inductive type magnetic head 5b.

The inductive type magnetic heads 5a and 5b in pair are disposed opposite to each other diametrically of the rotary drum 3 as having previously been described, so that recording is done alternately at the phase difference of 180 deg. between the magnetic heads 5a and 5b. Namely, the recording amplifier 41 provides a changeover between the timing of supplying the recorded signal to the one inductive type magnetic head 5a and that of supplying the recorded signal to the other inductive type magnetic head 5b alternately at the phase difference of 180 deg. between the magnetic heads 5a and 5b.

The recorded signal supplied to the signal transmitting ring 26a of the stator core 26 corresponding to the one inductive type magnetic head 5a is transmitted to the signal transmitting ring 27a of the rotor core 27 in the non-contact manner. The recorded signal thus transmitted to the signal transmitting ring 27a of the rotor core 27 is supplied to the inductive type magnetic head 5a which will record the signal onto the magnetic tape 7.

Similarly, the recorded signal supplied to the signal transmitting ring 26b of the stator core 26 corresponding to the other inductive type magnetic head 5b is transmitted to the signal transmitting ring 27b of the rotor core 27 in the non-contact manner. The recorded signal thus transmitted to the signal transmitting ring 27b of the rotor core 27 is supplied to the inductive type magnetic head 5b which will record the signal onto the magnetic tape 7.

For reproduction of a signal from the magnetic tape 7 by means of the rotary drum unit 1, a current is first supplied to the driving coil 31 of the motor 4. Thus the rotary drum 3 is rotated. While the rotary drum 3 is rotating, a high frequency current is supplied from an oscillator 42 to a power drive 43 as shown in FIG. 4.

The high frequency current from the oscillator 42 is converted to a predetermined alternating current by the power drive 43, and supplied to the power transmitting ring 26d of the stator core 26. Then, the AC current supplied to the power transmitting ring 26d of the stator core 26 is transmitted to the power transmitting ring 27d of the rotor core 27 in the non-contact manner. The AC current transmitted to the power transmitting ring 27d of the rotor core 27 is rectified to be a direct current by a rectifier 44 and supplied to a regulator 45 which will set the DC current for a predetermined voltage.

The current set for the predetermined voltage by the regulator 45 is supplied as a sense current to the pair of MR heads 6a and 6b. These MR heads 6a and 6b has connected thereto a reproducing amplifier 46 which detects a signal from each of the MR heads 6a and 6b. The current from the regulator 45 is also supplied to the reproducing amplifier 46.

The MR heads 6a and 6b comprise each an MR device of which the resistance varies depending upon the magnitude of the external magnetic field. Namely, the resistance of the MR device of each of the MR heads 6a and 6b varies with the magnetic field of a signal from the magnetic tape 7 so that it will reflect as a voltage change in the sense current.

The reproducing amplifier 46 detects the voltage change and provides as an reproduced signal a signal corresponding to the voltage change. It should be noted that the reproducing amplifier 46 provides a reproduced signal detected by one of the MR heads 6a at a timing of signal reproduction by the MR head 6a, and a reproduced signal detected by the other MR head 6b at a timing of signal reproduction by the other MR head 6b.

As previously mentioned, the MR heads 6a and 6b in pair are disposed opposite to each other diametrically of the rotary drum 3, so that reproduction is done alternately at the phase difference of 180 deg. between the MR heads 6a and 6b. Namely, the reproducing amplifier 46 provides a changeover between the timing of providing the reproduced signal to the one MR head 6a and that of providing the reproduced signal to the other MR head 6b alternately at the phase difference of 180 deg. between the MR heads 6a and 6b.

The reproduced signal from the reproducing amplifier 46 is supplied to the signal transmitting ring 27c of the rotor core 27 and transmitted to the signal transmitting ring 26c of the stator core 26 in the non-contact manner. The reproduced signal thus transmitted to the signal transmitting rung 26c of the stator core 26 is amplifier by a reproducing amplifier 47 and supplied to a correction circuit 48 where the reproduced signal is subjected to a predeternined correction and provided to the external circuit 40.

In the circuit configuration shown in FIG. 4, the pair of inductive type magnetic heads 5a and 5b, pair of MR heads 6a and 6b, rectifier 44, regulator 45 and the reproducing amplifier 46 are installed on the rotary drum 3, and hence rotatable along with the rotary drum 3. On the other hand, the recording amplifier 41, oscillator 42, power drive 43, reproducing amplifier 47 and the correction circuit 48 are disposed on the fixed portion of the rotary drum unit 1 or included in an external circuit provided separately from the rotary drum unit 1.

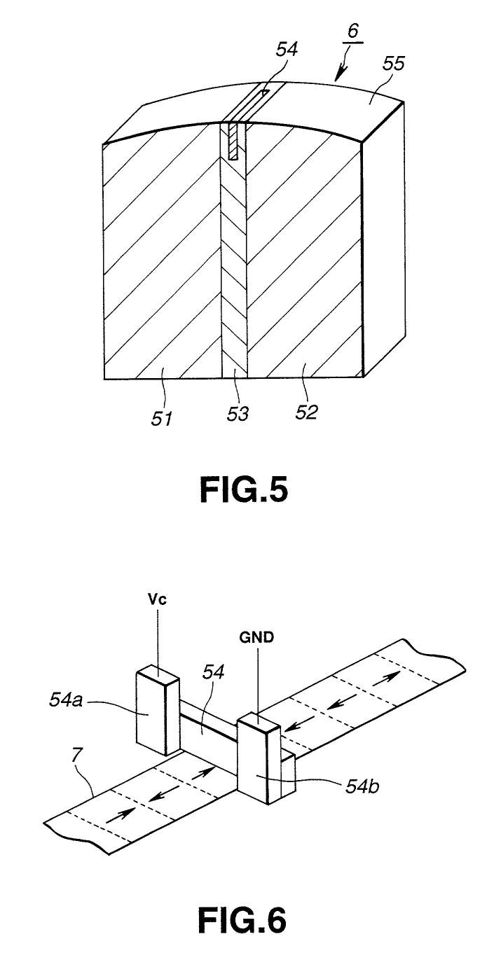

Next, the MR heads 6a and 6b mounted on the rotary drum 3 will be described in detail with reference to FIG. 5. Note that the MR heads 6a and 6b are identical to each other except that their azimuth angles are set opposite toe each other. Therefore, the MR heads 6a and 6b will be generally identified as MR head 6 herebelow.

The MR head 6 is installed on the rotary drum 3. It is a dedicated magnetic head for reproduction a signal from the magnetic tape 7 by the helical scan and under the magnetoresistance effect. Generally, the MR head has a higher sensitivity than the inductive type magnetic head for recording/reproduction based on the electromagnetic induction. It can provide a large reproduction output and is suitable for a high density recording. Therefore, the MR head 6 permits a higher density recording.

As shown in FIG. 5, the MR head 6 comprises a pair of magnetic shields 51 and 52 made of a soft magnetic material such as Ni—Zn polycrystalline ferrite or the like and a generally rectangular MR device 54 buried in an insulator layer 53 and sandwiched between the pair of magnetic shields 51 and 52. There is led out from opposite ends of the MR device 54 a pair of terminals through which a sense current is be supplied to the MR device 54.

The MR device 54 is a lamination of an MR element having the magnetoresistance effect, a SAL (soft adjacent layer), and an insulator layer disposed between the MR element and SAL layer. The MR element is formed from a soft magnetic material such as Ni—Fe or the like of which the resistance varies depending upon the magnitude of the external magnetic field under the anisotropic magnetoresistance effect (AMR). The SAL layer is made of a magnetic material having a low coercivity and high permeability such as Permalloy and provided to apply a bias magnetic field to the MR element by the so-called SAL bias method. The insulator layer is made of an insulative material such as Ta or the like and provided to provide an insulation between the MR element and SAL layer to prevent a shunt current loss.

The MR device 54 is formed to be rectangular, whose one side is exposed on a magnetic-tape sliding face 55 of the MR head 6 as shown in FIG. 5. It is buried in the insulator layer 53 buried in the insulator layer 53 and sandwiched between the pair of magnetic shields 51 and 52 as described in the foregoing. More particularly, the MR device 54 is disposed as above so that its short axis is generally orthogonal to the magnetic-tape sliding face 55 while its long axis is generally orthogonal to the sliding direction of the magnetic tape 7.

The magnetic-tape sliding face 55 of the MR head 6 is formed to have a cylindrical shape and polished along and orthogonally to the sliding direction of the magnetic tape 7. As mentioned above, one side of the MR device 54 is exposed on the magnetic-tape sliding face 55. Thus, the MR device 54 and its periphery of the MR head 6 are more protected than the rest. Therefore, the MR device 54 is in effective sliding contact with the magnetic tape 7.

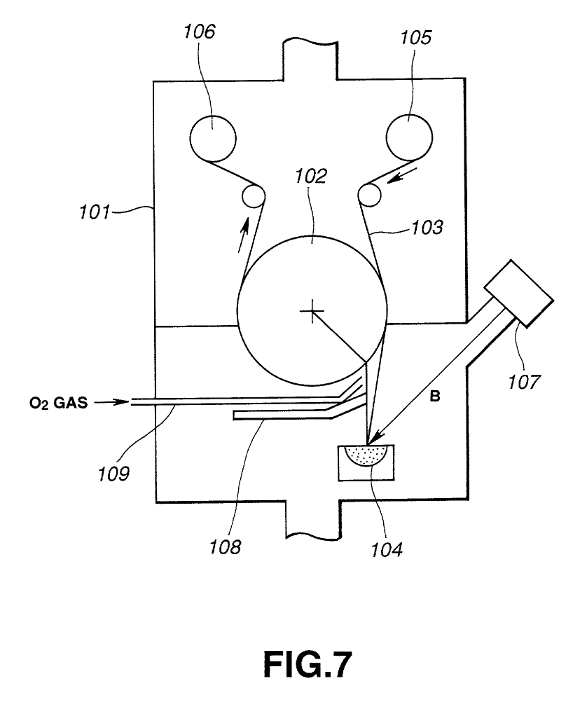

For reproduction of a signal from the magnetic tape 7 by the above-mentioned MR head 6, the magnetic tape 7 is slid on the MR device 54 as shown in FIG. 6. The arrows in FIG. 6 indicate how the magnetic tape 7 is magnetized.

While the magnetic tape 7 is sliding on the MR device 54, the MR device 54 is supplied with a sense current at the opposite terminals 54a and 54b thereof and a voltage change for the sense current is detected. More specifically, a predetermined voltage Vc is applied from the terminal 54a connected to one end of the MR device 54. The terminal 54b connected to the other end of the MR device 54 is connected to the rotary drum 3. The rotary drum 3 is electrically connected via the rotating shaft 21 which is connected to a ground potential. Thus, the terminal 54b of the MR device 54 is grounded via the rotary drum 3, rotating shaft 21 and stationary drum 2.

When the sense current is supplied to the MR device 54 while the magnetic tape 7 is sliding on the MR device 54, the MR element in the MR device 54 has the resistance thereofvaried depending upon the magnitude of the magnetic field from the magnetic tape 7, resulting in a voltage change for the sense current. Thus a signal magnetic field is detected from the magnetic tape 7 through the detection of the voltage change for the sense current, and a signal recorded on the magnetic tape 7 is reproduced.

Note that the MR device 54 in the MR head 6 may be made of any MR element which shows a magnetoresistance effect. For example, it may be formed from a so-called giant magnetoresistance effect (GMR) element formed from a lamination of thin layers and which shows a greater magnetoresistance effect. Also, the bias magnetic field may be applied to the MR element not in the SAL bias method but in any of various other methods including a permanent magnet bias method, shunt current bias method, self-bias method, exchange bias method, barber pole method, split element method, servo bias method, etc. for example. The giant magnetoresistance effect and various bias methods are described in detail in the “Magnetoresistance Head—Fundamentals and Applications” by Kazuhiko Hayashi, published by Maruzen.

Embodiments

The embodiments of the present invention will be further described hereinunder with reference to the results of experiments.

First, a polyethylene terephthalate film of 10 μm in thickness and 150 mm in width was prepared. A water-soluble latex containing acryl ester as main component was applied to the film surface to a density of 10,000,000 particles/mm² to form an undercoat.

Thereafter, a thin magnetic metal film of Co—O was formed on the undercoat under the film-forming following conditions:

Film-forming conditions

| | |
|---|---|
| Ingot | Co |
| Angle of incidence | 45 to 90 deg. |
| Tape line speed | 0.17 m/sec |
| Oxygen injection rate | 3.3 × 10⁻⁶ m³/sec |
| Evaporation vacuum | 7 × 10⁻² Pa |

A continuous take-up vacuum evaporation equipment was used in the experiments. As shown in FIG. 7, the vacuum evaporation equipment is composed of a vacuum chamber 101 in which there are disposed a cooling can 102 and a vacuum evaporator 104. The vacuum evaporator 104 is provided in a position opposite to the cooling can 102. In the vacuum evaporation equipment, a thin magnetic metal film is evaporated onto a nonmagnetic substrate 103 being moved on the cooling can 102. The nonmagnetic substrate 103 is fed from a supply roll 105, has the thin magnetic metal film formed as a magnetic layer thereon along the cooling can 102, and then taken upon onto a take-up roll 106.

The vacuum evaporator 104 is heated with an electron beam B irradiated from an electron beam source 107 to produce a vapor flow of a heated metallic material. The vapor flow is limited by a shutter 108 in angle of incidence relative to the nonmagnetic substrate 103, and mixed with a small amount of oxygen from an oxygen inlet tube 109 located near the shutter 108.

The magnetic recording medium thus produced had the easy axis (for which no demagnetization field is taken in account) thereof inclined about 20 deg. with respect to the main side of the thin magnetic metal film (magnetic layer).

Thereafter, a carbon layer of about 10 nm in thickness was formed on the magnetic layer thus formed by sputtering or CVD method.

Then, a backcoat layer of carbon and urethane resin is formed to a thickness of 0.6 μm on the opposite side of the nonmagnetic substrate to the side on which the magnetic layer has been formed as in the above. A lubricant of perfluoro ether is applied to the surface of the carbon layer. The product thus obtained is cut to a width of 8 mm to form a magnetic tape.

The sample tape was measured concerning the electromagnetic conversion characteristics. A remodeled 8-mm VTR was used to record an information signal of 0.5 μm in wavelength onto the sample tape. A shielded type MR head was used to test the sample tape as to the reproduction output, noise level and error rate.

The MR head element was an FeNi-AMR (aisotrophic magnetoresistance effect element) having a saturated magnetization of 800 emu/cc and film thickness of 40 nm. The shielding material used was NiZn, the inter-shield distance was 0.17 μm, the track width was 18 μm and azimuth angle was 25 deg.

The reproduction output (0.5 μm in recording wavelength) and noise level (value at a frequency 1 MHz lower than carrier signal) when the product Mr·δ of a remanent magnetization Mr and thickness δ of the thin magnetic metal film was changed are shown in Table 1.

In Table 1, the comparative embodiment 1 had the product Mr·δ of 0.5 memu/cm², the embodiment 1 had a product Mr·δ of 1.0 memu/cm², embodiment 2 had a product Mr·δ of 2.0 memu/cm², embodiment 3 had a product Mr·δ of 3.0 memu/cm², embodiment 4 had a product Mr·δ of 4.0 memu/cm², embodiment 5 had a product Mr·δ of 5.0 memu/cm², and the comparative embodiment 2 had a product Mr·δ of 6.0 memu/cm². The reproduction output and noise level were based on those of the embodiment 1. The error rate indicates a symbol error rate.

TABLE 1

| | Mr · δ | Reproduction | Noise level | |
|---|---|---|---|---|
| | (memu/cm²) | output (dB) | (dB) | Error rate |
| Comparative | 0.5 | −3.4 | −2.0 | 2 × 10⁻⁴ |
| Embodiment 1 | | | | |
| Embodiment 1 | 1.0 | 0 | 0 | 7 × 10⁻⁵ |
| Embodiment 2 | 2.0 | 3.2 | 2.0 | 3 × 10⁻⁵ |
| Embodiment 3 | 3.0 | 4.3 | 2.8 | 5 × 10⁻⁵ |
| Embodiment 4 | 4.0 | 6.1 | 3.4 | 7 × 10⁻⁵ |
| Embodiment 5 | 5.0 | 7.3 | 4.2 | 1 × 10⁻⁴ |
| Comparative | 6.0 | 7.2 (with | 5.5 | 5 × 10⁻³ |
| example 2 | | distortion) | | |

As seen from Table 1, when the remanent magnetization and film thickness product Mr·δ is below 1 memu/cm² (as in the comparative example 1), no sufficient reproduction output can be provided. If the product Mr·δ is over 5 memu/cm² (as in the comparative example 2), the MR element is saturated, and thus the reproduction waveform shows a distortion and the error rate is deteriorated. Therefore, the product Mr·δ should preferably be within a range of 1 to 5 memu/cm².

The products Mr·δ of the embodiments of the magnetic recording medium according to the present invention will be seen from Table 1. However, a same value of the product Mr·δ includes countless kinds of combinations of remanent magnetization Mr and film thickness δ. The magnetic recording medium of the present invention was further tested on the thickness and remanent magnetization of the thin magnetic metal film in the magnetic recording medium.

Table 2 shows the output reproduction, noise level and error rate when the thickness δ of the thin magnetic metal film was varied. The reproduction output and noise level were based on the embodiment 6. The remanent magnetization of the thin magnetic metal film was 360 emu/cc for all the comparative examples and embodiments in these tests.

TABLE 2

| | Film thickness | Reproduction | Noise level | Error |
|---|---|---|---|---|
| | δ (nm) | output (dB) | (dB) | rate |
| Comparative | 20 | −3.2 | −1.8 | 2 × |
| embodiment 3 | | | | 10⁻⁴ |
| Embodiment 6 | 30 | 0 | 0 | 9 × |
| | | | | 10⁻⁵ |
| Embodiment 7 | 50 | 3.6 | 1.4 | 7 × |
| | | | | 10⁻⁵ |
| Embodiment 8 | 80 | 5.3 | 2.8 | 5 × |
| | | | | 10⁻⁵ |
| Embodiment 9 | 100 | 6.2 | 3.7 | 3 × |
| | | | | 10⁻⁵ |
| Embodiment | 120 | 7.4 | 4.3 | 7 × |
| 10 | | | | 10⁻⁵ |
| Comparative | 150 | 7.2 | 5.6 | 3 × |
| example 4 | | (with | | 10⁻³ |
| | | distortion) | | |

If the film thickness δ is over 150 nm as in the comparative example 4, the MR element will be saturated, the waveform will be distorted. When the film thickness δ is below 20 nm as in the comparative example 3, no sufficient reproduction output can be obtained and the coercivity is deteriorated, so that the resolution shows a tendency to be lower. As known from these test results, the thickness δ of the thin magnetic metal film should optimally be 30 to 120 nm.

Next, the samples were tested on the reproduction output, noise level and error rate when the remanent magnetization Mr was varied with the film thickness δ was fixed at 120 mn. The test results are shown in Table 3. The reproduction output and noise level were based on the embodiment 11.

TABLE 3

| | Remanent | | Noise | |
|---|---|---|---|---|
| | magnetization | Reproduction | level | |
| | (Mr (emu/cc) | output (dB) | (dB) | Error rate |
| Comparative | 150 | −2.4 | −1.8 | 5 × 10⁻⁴ |
| example 5 | | | | |
| Embodiment 11 | 200 | 0 | 0 | 1 × 10⁻⁴ |
| Embodiment 12 | 250 | 2.1 | 2.4 | 7 × 10⁻⁵ |
| Embodiment 13 | 300 | 3.8 | 3.4 | 5 × 10⁻⁵ |
| Embodiment 14 | 350 | 4.2 | 3.9 | 7 × 10⁻⁵ |
| Embodiment 15 | 400 | 6.3 | 4.4 | 8 × 10⁻⁴ |
| Comparative | 450 | 6.2 | 5.4 | 3 × 10⁻³ |
| example 6 | | (with | | |
| | | distortion) | | |

As seen from Table 3, when the remanent magnetization Mr is small as in the comparative example 5, no sufficient reproduction output can be obtained as compared with the embodiments of the present invention. If the remanent magnetization Mr is too large as in the comparative example 6, the coercivity is lower while the noise is higher, so that the resolution is lower.

Next, the magnetic recording medium was tested on the reproduction output, noise level and error rate when the coercivity measured in the thin magnetic metal film of the magnetic recording medium was varied. The test results are shown in Table 4. The reproduction output and noise level are based on the embodiment 16.

TABLE 4

| | Co- | | Noise | Rect- | |
|---|---|---|---|---|---|
| | ercivity | Reproduction | level | angular | Error |
| | (Oe) | output (dB) | (dB) | ratio | rate |
| Comparative | 800 | −2.1 | −1.2 | 0.91 | 3 × |
| example 7 | | | | | 10⁻⁴ |
| Embodiment 16 | 1000 | 0 | 0 | 0.84 | 8 × |
| | | | | | 10⁻⁵ |
| Embodiment 17 | 1500 | 1.5 | −0.8 | 0.80 | 7 × |
| | | | | | 10⁻⁵ |
| Embodiment 18 | 2000 | 3.3 | −1.3 | 0.76 | 7 × |
| | | | | | 10⁻⁵ |
| Embodiment 19 | 2300 | 2.8 | −1.9 | 0.70 | 3 × |
| | | | | | 10⁻⁴ |
| Embodiment 20 | 2500 | 2.0 | −2 | 0.62 | 7 × |
| | | | | | 10⁻⁴ |
| Comparative | 3000 | −0.5 | −2.6 | 0.58 | 5 × |
| example 8 | | | | | 10⁻³ |

The comparative example 7 shows a small coercivity and a high noise level. The comparative example 8 shows too large a coercivity to hardly record, and a low reproduction output. Therefore, the coercivity should preferably be 1,000 to 2,500 Oe.

Table 4 also shows the rectangular ratio measured intra-plane direction when the coercivity was varied. The rectangular ratio should preferably be 0.6 to 0.9 from the standpoints of the reproduction output and noise level.

As having been described in the foregoing, since the remanent magnetization and film thickness product Mr·δ of the thin magnetic metal film in the magnetic recording medium according to the present invention is optimized to match the characteristics of the MR read head, it is possible to prevent the MR element from being saturated and attain a high output and a low noise.

In particular, use of the magnetic recording medium according to the present invention as a recording medium with a helical scanning magnetic recording system using a shielded type MR read head permits to attain a higher density of recording than ever.

What is claimed is:

1. A magnetic recording medium comprising a nonmagnetic substrate and a thin magnetic metal film formed on the nonmagnetic substrate, the product Mr·δ of a remanent magnetization Mr and thickness δ of the thin magnetic metal film being 1 to 5 memu/cm².

2. The magnetic recording medium as set forth in claim 1, wherein the remanent magnetization Mr is 200 to 400 emu/cc.

3. The magnetic recording medium as set forth in claim 1, wherein the film thickness δ is 30 to 120 nm.

4. The magnetic recording medium as set forth in claim 1, wherein the coercivity in the intra-plane direction is 1,000 to 2,500 Oe.

5. The magnetic recording medium as set forth in claim 1, wherein the squareness in the inplane direction is 0.6 to 0.9.

6. The magnetic recording medium as set forth in claim 1, usable with a helical scanning magnetic recording system using a magnetoresistance effect read head.
